(19) United States
(12) Patent Application Publication
(10) Pub. No.: US 2007/0036139 A1
(43) Pub. Date: Feb. 15, 2007

(54) System and method for authenticating internetwork resource requests

(76) Inventors: Ashish Patel, Thornton, CO (US); Carleton Anthony Smith, Westminster, CO (US); Gregory Wilfred Bruening, Boulder, CO (US)

Correspondence Address: MICHELE ZARINELLI;c/o WEST CORPORATION, 11808 MIRACLE HILLS DRIVE, MSW11 - LEGAL, OMAHA, NE, 68154, US

(21) Appl. No.: 11/199,549

(22) Filed: Aug. 9, 2005

(51) Int. Cl. H04L 12/66

(52) U.S. Cl. 370/352

(57) ABSTRACT

A method for use in diverse networks that authenticates inter-network resource requests. A router in a first network receives a request for a resource from a second network. The router sends a query to an element in the second network to determine whether the request actually originated there. If the request did originate from the second network, the request is processed according to the procedure for the requested resource. If the request did not originate from the second network, then the first network terminates the request. Thus, no network resources are consumed unnecessarily by accidental or malicious requests.

### BACKGROUND OF THE INVENTION

This invention relates to the field of sharing resources between diverse communication networks, and, more specifically, to protecting such shared resources from accidental or deliberate depletion.

In the not-too-distant past, there was only one communication network available to the public: the telephone network (herein called the “public switched telephone network” or “PSTN”). Now data communication networks, formerly available solely to government or big business, are also generally available to the public. Because the telephone and data networks were developed for different purposes and at different times, the PSTN is a “circuit switched” network and data networks are generally “packet switched” networks. Given these differences in purpose and protocol, there was initially little to no interaction between them. Thus, there was no motivation to design or develop resources that could be shared between or among the diverse networks. Over the past decade or so, however, the line of demarcation between these networks is becoming blurred to the point of disappearing.

For example, data networks now carry voice calls. A popular class of service that carries voice calls in a data network is voice over Internet protocol (VoIP). Gateways that translate format and protocol are used to connect calls that span the PSTN and VoIP data network. Because of this relatively recent interaction between voice and data networks, there is a need for resources and services in the data networks that were formerly only available in the PSTN.

One essential telecommunications resource that is primarily implemented in the PSTN is emergency services, the services that are popularly known in the U.S. as “9-1-1.” However, one system and method for providing 9-1-1 service in VoIP telephony has recently been implemented by Intrado, the assignee of this invention (herein referred to as the “Intrado solution”). This system and method is described in U.S. Pat. No. 6,771,742, to McCalmont et al., U.S. patent application Ser. No. 10/288,737 and U.S. patent application Ser. No. 10/402,741 by Knox, all of which are assigned to the assignee of this invention and all of which are hereby incorporated by reference in their entirety.

In the above-referenced system, the user of a VoIP telephone dials 9-1-1, which is received by the VoIP controller for routing. The VoIP controller assigns an emergency services routing number (ESRN) and sends the call into the PSTN. The ESRN is a preassigned telephone number that causes the PSTN to route the 9-1-1 call to a public safety answering point (PSAP) that is proximal to the calling telephone.

A problem in the current art is that the ESRN comprises a 10-digit telephone number that may be dialed at any telephone in the PSTN or the data network. For example, the ESRN can be dialed by any auto-dialer (used by solicitors, for example) that incrementally or randomly dials telephone numbers. Further, a user on the data network may accidentally or maliciously cause the same number to be dialed repeatedly, causing resource flooding and ultimately resulting in denial of service to those who really need emergency services.

### SUMMARY OF THE INVENTION

This problem is solved and a technical advance is achieved in the art by a system and method that authenticates an inter-network resource request to verify that the request for a resource on a first network is properly originating on a second network. In one embodiment, a router in the first network receives a resource request from an inter-network gateway. The router then sends a query to the network gateway to determine whether the request actually originated there. If the request did originate from the network gateway, processing continues according to the procedure for the requested resource. If the request did not originate from the network gateway, then the system terminates the request, sends it to announcements, etc., thus using fewer system resources.

An example of the first network is the public switched telephone network (PSTN) and an example of the second network is a data network that supports voice over Internet protocol (VoIP) telephony. An exemplary resource that is available only on the first network is emergency services (9-1-1). When a VoIP telephone dials 9-1-1, a gateway between the two networks out-pulses an emergency services routing number (ESRN) and an emergency services query key (ESQK) or an automatic number identification (ANI) into the PSTN. In accordance with this invention, a router in the PSTN receives the ESRN and requests authentication from the gateway that apparently initiated the call. Advantageously, the gateway may be determined from the ESRN and the ESQK or ANI of the calling telephone. The gateway passes a token indicating whether it did in fact initiate the call. If the call is thus authenticated, the call is completed to emergency services. If the call cannot be authenticated, then the call is terminated or given some type of call treatment, such as sent to signals (e.g., fast busy, reorder) or announcements.

In accordance with another embodiment of this invention, an authentication request is sent from the router to a network component, such as a service control point, which traces the origin of the call to ensure that it is legitimate. According to another embodiment of this invention, a token is passed from a network gateway to the selective router (on, for example, a signaling network) when the network gateway outpulses an ESRN. When the selective router receives the ESRN, it checks for the token on the signaling network to authenticate the call. In this manner, randomly dialed and malicious flooding are avoided at the network resource, helping to ensure its availability for real requests for services from both networks.

### BRIEF DESCRIPTION OF THE DRAWINGS

A more complete understanding of this invention may be obtained from a consideration of this specification taken in conjunction with the drawings, in which:

FIG. 1 is a block diagram of exemplary networks in which embodiments of this invention operate;

FIG. 2 is a call flow diagram of authenticating an inter-network request for use of a resource in accordance with an exemplary embodiment of this invention in the context of the networks of FIG. 1;

FIG. 3 is a call flow diagram of authenticating an inter-network request for use of a resource in accordance with another exemplary embodiment of this invention in the context of the networks of FIG. 1; and

FIG. 4 is a block diagram illustrating an alternate embodiment of the present invention.

### DETAILED DESCRIPTION

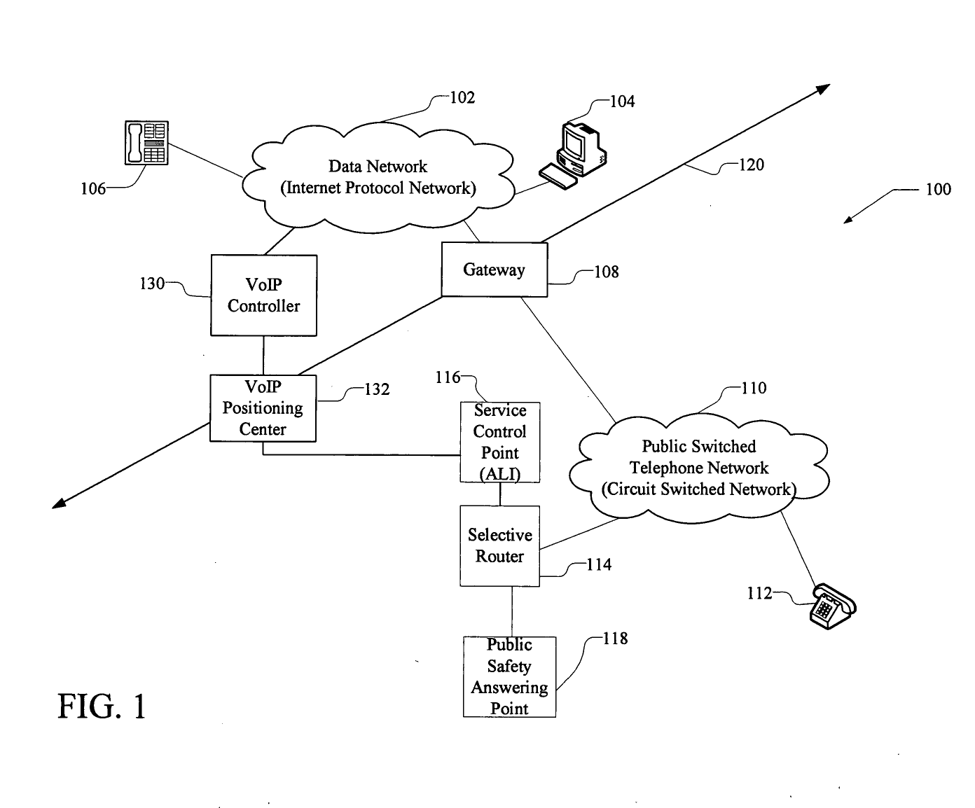

FIG. 1 is a block diagram of exemplary diverse networks in which embodiments of the current invention may be implemented, shown generally at 100. This exemplary embodiment includes a data network 102, which provides packet switched communications for digital devices. Such digital devices are represented by and include (but not limited to) personal computer 104 and voice over internet protocol (VOIP) telephone 106. Data network 102 may be any public or private network including, but not limited to, the Internet.

Data network 102 is connected via gateway 108 to the public switched telephone network (PSTN) 110. PSTN 110 provides circuit switched communications for telephones and other devices, represented by telephone 112. PSTN 110 includes selective router 114 and service control point 116. Service control point 116 may comprise an automatic location identification (ANI) node, as is known in the art, or other database system. PSTN 110 also includes public safety answering point (PSAP) 118 to provide emergency or 9-1-1 service for a predefined geographic area.

An interface line 120 defines the limits of each network for purposes of clarity. One skilled in the art will realize that the various components illustrated herein are not segregated into discrete networks with one definable interface. While gateway 108 is herein illustrated at interface 120 between data network 102 and PSTN 110, it is known in the art that gateway 108 may be a part of data network 102, PSTN 110 or both.

Providing emergency service for VoIP is used herein to illustrate the features and advantages of this invention. VoIP operates in one network (data network 102) but uses a resource (PSAP 118) from a diverse network (PSTN 110) in order to provide such 9-1-1 service. One skilled in the art will appreciate how to apply the principals of this invention to other diverse network applications after studying this specification. Further, one skilled in the art will appreciate that the principals of this invention apply to sharing resources between diverse data networks.

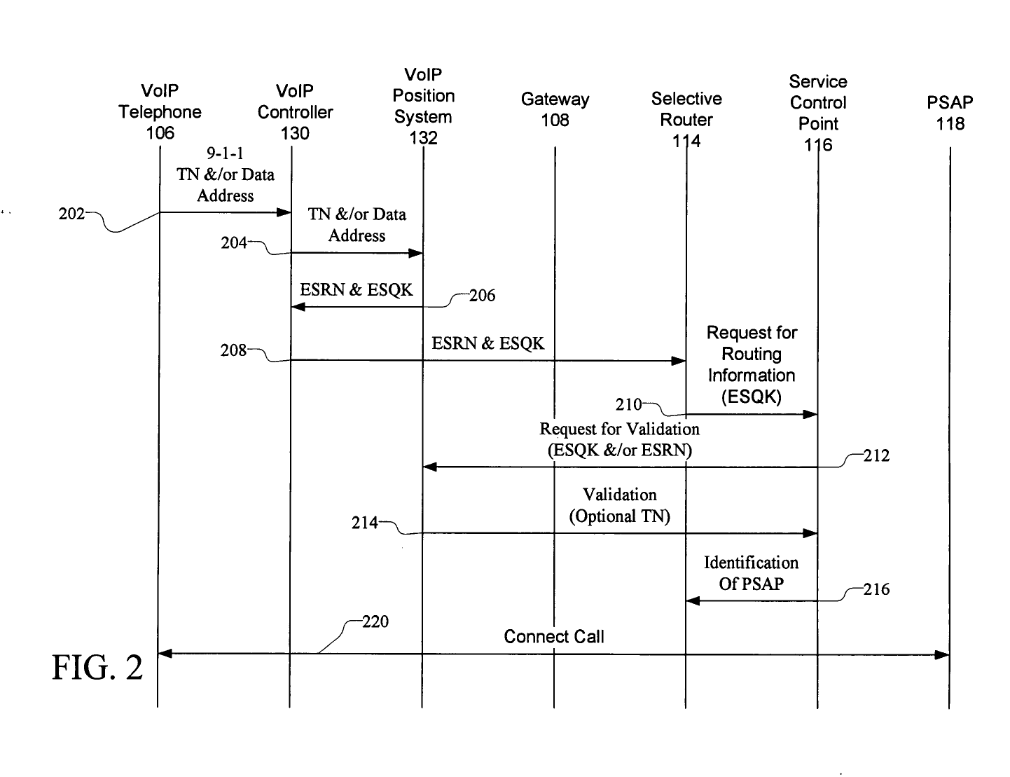

An exemplary embodiment of this invention is now described with reference to FIG. 1, which illustrates a block diagram of one network using a resource on a diverse network, and FIG. 2, which illustrates a call flow in the context of FIG. 1. The call flow steps are indicated in the following text by parentheses. The herein described system and method employs the principals of the Intrado solution for 9-1-1 VoIP. For a more detailed explanation of the Intrado solution, see the above-incorporated patents and applications.

When the user of VoIP telephone 106 dials 9-1-1, the call is first handled by the user's service provider's VoIP controller 130 (202). The initial call may include the telephone number of telephone 106, the data address of telephone 106 or both. VoIP controller 130 recognizes the special number (9-1-1) and requests instructions from a VoIP positioning center 132, passing the telephone number, the data address, or both, of the calling telephone 106 (204).

In accordance with this exemplary embodiment of this invention, VoIP positioning center 132 maintains a database of the locations of VoIP telephones and the PSAP that serves each location. VoIP positioning center 132 uses the telephone number, the data address, or both, to perform a look up in its database. If the telephone number is found in its database, VoIP positioning center 132 passes an emergency services routing number (ESRN) and an emergency services query key (ESQK) to VoIP controller 130 (206). The ESRN comprises a 10 digit number in the same format as all telephone numbers (i.e., NPA-NXX-XXXX). The ESRN causes PSTN 110 to route the call to a predetermined selective router (114 in this exemplary embodiment) that serves the general geographic area in which the calling telephone is located. The ESQK is the equivalent of the automatic number identification (ANI), which is used by selective router 114 to further define which PSAP 118 serves the specific area in which the calling telephone is located.

Alternatively, a VoIP telephone, such as 104, may have information regarding its position stored in its memory system. When queried, VoIP positioning center 132 sends a message to VoIP telephone 104 requesting its position. VoIP telephone 104 sends its position to VoIP positioning center 132, which then uses the received position to determine the ESRN and ESQK.

VoIP controller 130 routes the call into PSTN 110 via gateway 108 using the ESRN as the dialed number and the ESQK as the dialing number (i.e., ANI or caller ID) (208). The ESRN directs call processing to route the call through PSTN 110 to selective router 140 that is proximal to the calling telephone 106. Selective router 140 queries a database, herein illustrated as service control point 142, to determine which PSAP handles calls from the area of the calling telephone (210). “Service control point” is used herein to mean a network component that performs a function. In the exemplary embodiments of this invention, service control point may also be called an “ALI database” and have the same functionality as an ALI database as known in the art. Further, service control point 142 is illustrated herein as comprising the routing database for purposes of clarity, one skilled in the art will appreciate that the routing database for selective router 114 may be, for example, a dedicated system or may be an entity on a separate signaling network (e.g., an SS7 network), data network or the switch itself.

Continuing with this exemplary embodiment of this invention, service control point 142 requests authentication from VoIP position server 132 (212). Service control point 142 forwards the ESQK and the ESRN it received to determine if VoIP position server 132 assigned these numbers to an emergency call.

In the above-described scenario, VoIP position server 132 did assign the ESRN and ESQK numbers for a 9-1-1 call from VoIP telephone 106. Therefore, VoIP position server 132 sends a validation or positive response to service control point 142 (214). Such positive response may include a token. Advantageously, VoIP position server 132 may additionally deliver the telephone number of VoIP telephone 106 (for call back or other purposes). Service control point 142 also sends an identification of the PSAP (in this example, PSAP 118) that serves the location of calling telephone 106. The call is connected to PSAP 118 (220).

If, on the other hand, the ESRN, ESQK or both were not issued by VoIP position server 132, service control point 142 may cause the call to terminate, send the call to announcement or signals and take other action as appropriate. Alternatively, service control point 142 may send a denial of service signal back to selective router 114 or some other point in PSTN 110 to take appropriate action.

The above-described 9-1-1 call scenario illustrates an authenticated resource request between diverse networks. Because the ESRN is a dialable 10 digit number, any telephone in either PSTN (such as telephone 112) or in data network 102 (such as VoIP devices 104 and 106) can dial it at any time, either accidentally (a misdial or an automatic dialer) or maliciously. Furthermore, a computer device such as PC 104 can dial an ESRN repeatedly in just a few seconds, which quickly ties up all connections to PSAP 118 and causes a denial of service to real emergency calls from both networks. Furthermore, a PC in PSTN 104 with a network card (e.g., a T1 card) may flood the PSAP 118 by repeatedly dialing an ESRN.

Thus, calls from PSTN 110 (e.g., from telephone 112) to the ESRN can be rejected and delivered to terminal call treatment (e.g., fast busy signal, reorder signal, announcement, etc.). Further, gateway 108 can verify that the call is from a legitimate source on the network and not one source attempting to flood the resource without legitimate reasons.

Alternatively, VoIP controller 130 may block calls to predetermined numbers. Thus, no calls to one or more ESRN's may be blocked at VoIP controller 130, thus stopping the call before it reaches PSTN 110. Further, SCP 116, selective router 114 or both may be programmed to recognize when a string of calls arrives from the same ANI and stop processing the call at that point.

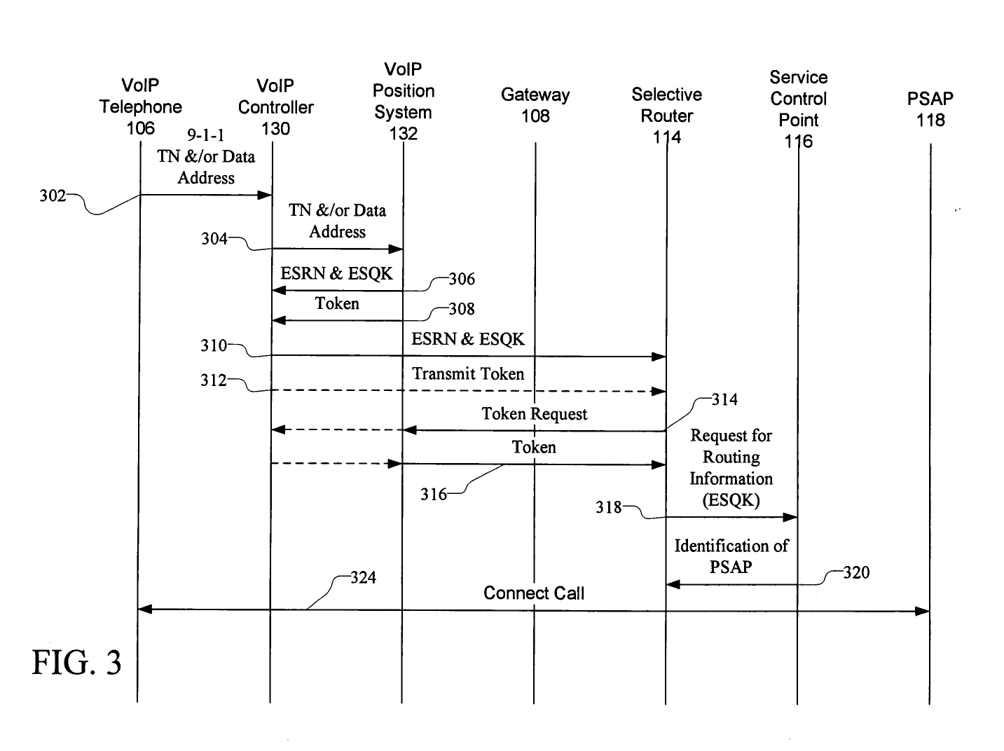

Turning now to FIG. 1 and FIG. 3, a further exemplary embodiment and method of this invention is described. As in the above-described embodiment, the user of VoIP telephone 106 dials 9-1-1, which call is routed to VoIP controller 130, along with the telephone number, the data address, or both, of the VoIP telephone 106 (302). VoIP controller 130 queries VoIP position system 132 with the telephone number, data address, or both (304) as described above. VoIP position system 132 responds with an ESRN and an ESQK (306). Additionally, and in accordance with this exemplary embodiment, VoIP position system 132 produces a token and delivers it to the VoIP controller 130 (308). Alternatively, VoIP controller 130 may generate a token when it receives an ESRN and ESQK.

VoIP controller 130 uses the ESRN to route the call through gateway 108 to selective router 114, passing the ESRN and the ESQK (310). At this point, VoIP controller 130 may pass the token to selective router 114, either over the same connection as the ESRN and the ESQK (known in the art as “in band”) or over a separate signaling network (“out of band”) (312). Alternatively, selective router 114 may request a token from either the VoIP controller 130 or VoIP position system (314) to which either may respond with the token (316).

Once the token is received, selective router 114 requests routing information from service control point 116 (318). The identification of the destination PSAP (i.e., ESN or PSAP ID) is returned (320) and the call is connected (324). If selective router 114 does not receive the token then it can assume that the call is not authentic and can take appropriate action (disconnect, announcement, signals, etc.).

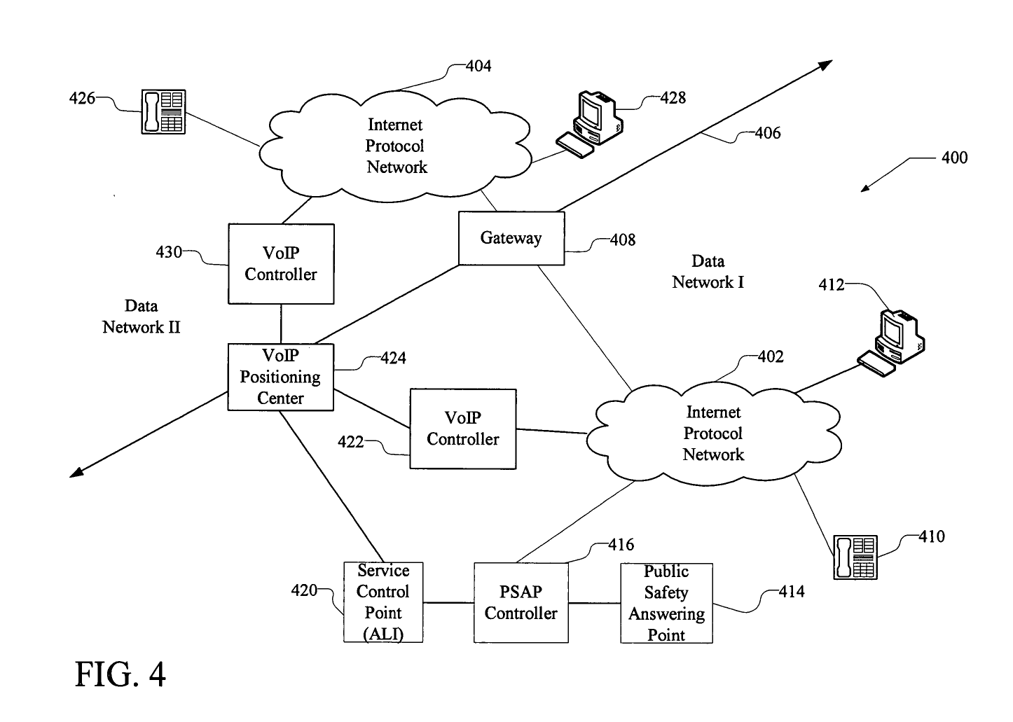

Turning now to FIG. 4, an alternative embodiment of this invention illustrating two diverse data networks is shown, generally at 400. In FIG. 4, data networks 400 comprise a first Internet protocol network 402 and a second Internet protocol network 404. First and second data networks are separated by boundary 406, which is, of course, for convenience of illustration. Internet protocol network 402 and Internet protocol network 404 are connected at boundary 406 by a gateway 408. Gateway 408 performs any protocol or other conversion as is known in the art. Gateway 408 is optional (in the case where no conversion is needed between the two networks), is known in the art and is therefore not further discussed.

In the illustration of FIG. 4, Internet protocol network 402 supports a plurality of VoIP telephones, represented by telephone set 410 and PC 412. Further, Internet protocol network 402 supports a public safety answering point (PSAP) 414. PSAP 414 is connected to Internet protocol network 402 via a PSAP controller 416. PSAP 414 may communicate using VoIP protocol, in which case PSAP controller 416 comprises a router. PSAP 414 may also be a conventional circuit-switched system, in which case PSAP controller 416 provides conversion from VoIP to circuit switch communication, signaling conversion, etc. PSAP controller 416 is also illustrated as connected to service control point 420 (which may be an ALI database). As described above in connection with FIG. 1, service control point 420 may be a separate system, part of PSAP controller 416 or some other node in data network I. Internet protocol network 402 also includes a VoIP controller 422, which is connected to VoIP positioning center 424.

Internet protocol network 404 in data network II supports a plurality of VoIP telephone sets, represented by telephone set 426 and PC 428. VoIP is supported in Internet protocol network 404 by VoIP controller 430. VoIP controller 430 is connected to VoIP positioning center 424.

In the exemplary embodiment of FIG. 4, a 9-1-1 call is made at telephone 426, for example. The call initiation is routed through Internet protocol network 404 to VoIP controller 430. VoIP controller 430 recognizes the special nature of the call, queries VoIP positioning center 424 for the location of VoIP telephone 426 and assigns an ESRN and ESQK accordingly. The call initiation is then routed back through Internet protocol network 404, through gateway 408 (if required) and into Internet protocol network 402. VoIP controller 422 receives the call initiation and routes the call initiation according to the ESRN and ESQK, which causes the call to be routed to PSAP controller 416.

PSAP controller 416 causes a call to be set up between one of the positions at PSAP 414 and queries service control point (ALI) 420 for information regarding the call. Service control point 420 uses the ESRN and ESQK to query VoIP positioning center 424 to obtain information related to telephone 426. Service control point 420 delivers the received information to PSAP 414 via PSAP controller 416.

It is to be understood that the above-described embodiment is merely illustrative of the present invention and that many variations of the above-described embodiment can be devised by one skilled in the art without departing from the scope of the invention. For example, a third network may be used for communication among the components of PSTN 110, such as an SS7 network. Any of the network control points or service control points in either or both networks can communicate over the communications network to request verification from gateway 108, VoIP controller 130, VoIP position system 132 or any combination thereof. It is therefore intended that such variations be included within the scope of the following claims and their equivalents.

1. A method comprising:
receiving a request for use of a resource in a first network from a requester in a second network;
authenticating the request in the second network that the request originated legitimately from the requester; and
connecting the resource in the first network to the requester in the second network responsive to receipt of authentication.

2. A method in accordance with claim 1 wherein authenticating the request comprises requesting an authentication token by the resource's allocator and receipt of the authentication token from the second network by the allocator.

3. A method in accordance with claim 1 wherein authenticating the request comprises receiving an authentication token by the resource's allocator as part of the request.

4. A method in accordance with claim 1 wherein the first network includes a service control point and wherein the method further comprises:
querying the service control point by the resource's allocator to authenticate that the resource request originated properly on the second network; and
wherein authenticating the request comprises the service control point communicating with the requester in the second network; and
wherein connecting the resource comprises receiving the authentication at the service control point and the service control point delivering processing instructions to the resource's allocator.

5. A method for use in sharing a telephone network resource between the telephone network and a data network comprising:
routing a request for the telephone network resource from the data network to the telephone network;
authenticating the request for the telephone network resource by authenticating an origination of the request in the data network; and
connecting the telephone network resource to the data network responsive to authenticating the request for the telephone network resource.

6. A method in accordance with claim 5 wherein a controller routes the request from the data network to the telephone network; and wherein the controller authenticates the request for the telephone network resource.

7. A method in accordance with claim 5 wherein the telephone network includes a service control point, and wherein the service control point authenticates the request for the telephone network resource.

8. A method in accordance with claim 5 wherein a controller routes the request from the data network to the telephone network and the telephone network includes a service control point, and wherein the controller and the service control point cooperatively authenticate the request.

9. A method in accordance with claim 5 wherein a controller routes the request from the data network to the telephone network and the telephone network includes a router that allocates the telephone network resource; and wherein the controller and the router cooperatively authenticate the request.

10. A method for authenticating a telephone network resource request from a data network comprising:
processing a request for the resource by a controller in the data network;
sending the request for the resource from the controller to a router in the telephone network;
generating an authentication of the resource request in the data network; and
allocating the resource responsive to the router receiving the authentication.

11. A method in accordance with claim 10 wherein processing a request for the resource comprises generating routing information in the data network and wherein generating an authentication of the resource request comprises generating an authentication token and sending the authentication token to the router.

12. A method for authenticating a 9-1-1 call from a VoIP network comprising:
routing the 9-1-1 call to a selective router in a telephone network by a VoIP controller in the VoIP network;
generating an authentication in the VoIP network that the 9-1-1 call originated from the VoIP network; and
routing the 9-1-1 call to a PSAP responsive to the selective router receiving the authentication.

13. A method in accordance with claim 12 wherein the step of routing the 9-1-1 call to a selective router by a VoIP controller comprises:
generating an ESRN and an ESQK responsive to a location of an origination of the 9-1-1 call;
sending the ESRN and ESQK into the telephone network as a routing telephone number and an automatic number identification, respectively.

14. A method in accordance with claim 13 wherein generating an authentication in the VoIP network comprises generating an authentication that the ESRN and ESQK were generated by the VoIP network.

15. A method in accordance with claim 14 further comprising requesting the authentication from the selective router before routing the 9-1-1 call to the PSAP.

16. A method in accordance with claim 14 wherein the authentication is sent to the selective router along with the ESRN and the ESQK.
